(19) United States
(12) Patent Application Publication
(10) Pub. No.: US 2005/0165689 A1
(43) Pub. Date: Jul. 28, 2005

(54) Allowing recording based on regions

(76) Inventors: Raymond J. Krasinski, Suffern, NY (US); Michael Abraham Epstein, Spring Valley, NY (US)

Correspondence Address: PHILIPS INTELLECTUAL PROPERTY & STANDARDS, P.O. BOX 3001, BRIARCLIFF MANOR, NY, 10510, US

(21) Appl. No.: 10/511,316

(22) PCT Filed: Apr. 15, 2003
(86) PCT No.: PCT/IB03/01505

Related U.S. Application Data
(60) Provisional application No. 60/372,893, filed on Apr. 16, 2002.
(60) Provisional application No. 60/432,889, filed on Dec. 12, 2002.

(51) Int. Cl. H04K 1/00

(52) U.S. Cl. 705/57; 380/201

(57) ABSTRACT

A device (10) for recording content onto a medium (14) includes a processor (22) which is configured to read a first code (16) embedded in the medium (14), a second code embedded in a memory (12) of the recording device (10), and a third code embedded in the content (18). The processor (22) compares the three codes and allows recordation of the content (18) onto the medium (14) when the three codes are identical. The three codes are region codes indicative of the region of broadcast of the content (18), the broadcast time or the time zone of the region of broadcast. The recording device (10) prevents recordation when a content code included in the content (18) does not match the other two codes or their difference is greater than a predetermined amount.

The invention relates to allowing recordation of content onto a medium based on regions. More particularly, source content is allowed to be recorded onto recordable media after encryption if identical region codes are detected in the source content, the recordable media, and the recording apparatus.

With conventional DVD (Digital Video Disk) recordable technology, it is possible to make copies of content, such as broadcast content. It is desirable to allow users of recording devices to make a copy of the broadcast content for time shifting purposes, so that the content may be viewed at a time different from the time the content was broadcasted. U.S. Pat. No. 6,310,956, which is incorporated herein by reference in its entirety, describes a system that allows recording for time-shifting purposes by comparing transmission time information embedded in a data stream with the current time at the data recorder. Recording is allowed if the time difference between the transmission time and the current time is less than a threshold value.

Further, it is not desirable to allow a user to make multiple copies of the content and distribute the content widely. Typically, broadcasters broadcast content at one time in one region, and a later time in a different region. For example, broadcasters may broadcast content within the United States on a specific date, and resell the same content for broadcast oversees, such as for broadcast in European markets at a later time and/or date. The same may be desirable within different time zones of the United States, such as the Eastern and Pacific time zones. The ability of users to copy and/or retransmit a data stream whether broadcasted or released on a medium such as a DVD (hereinafter collectively referred to as content), which was first broadcasted or released in one region and distribute the copied content in other regions prior to the broadcast or distribution in such different regions damages the broadcasters, e.g., by reducing viewership and revenues from advertising or selling authorized copies of the DVD. The ability to make many copies of any content such as data recorded on a medium, e.g., DVD, or data from television, radio, satellite, or Internet such as web pages, web broadcasts, DVB (Digital Video Broadcasts) whether terrestrial or via satellite, and distribute the content over any means, such as the Internet, is one such disruptive use.

Thus, it is desirable to prevent unauthorized copying of content, and distributing and replaying the copied content in different regions. For example, a DVD, a television program, a movie or any other content, may be released in the United States and not yet released in Europe. In this example, it is desirable to prevent distribution in Europe of unauthorized copies of the content released in the United States.

Accordingly, there is a need to prevent copying, distribution and retransmission of content. The present invention provides a convenient and protected system that can perform substantially all of the tasks consumers wish to accomplish, while preventing undesirable tasks such as preventing unauthorized copying as well as preventing distribution and transmission of any unauthorized copies of content such as through the Internet.

According to the invention, a device for recording content onto a medium comprises a processor which is configured to read three codes, namely, a first code embedded in the medium, a second code embedded in the device, and a third code embedded in the content. The processor compares the three codes and allows reproduction, such as recordation, copying and playback, of the content onto the medium when all three codes are identical. Illustratively, the first code includes regions where the medium is useable for recording the content, the second code includes regions the recording device is useable for recording the content, and the third code is indicative of the origin or region of broadcast of the content.

The three codes may further include time zones. For example, the first code may also include a first time zone related to where the medium is useable, the second code may further include a second time zone related to where the recording device is useable, e.g., for recording, and the third code may further include a third time zone of broadcast origin of the content. In this case, the processor is configured to allow recording when the three time zones are substantially identical.

In addition or alternatively, the second code may further include a current time obtained from a timing module of the reproducing device for example, and the third code may further include a broadcast time of the content. In this case, the processor may be further configured to prevent the reproduction when the difference between the current time and the broadcast time is greater than a predetermined threshold value, for example.

For added security, the device may also include an encoder which is configured to encode the content using at least one key imbedded in the medium to form an encoded content for recording onto the medium.

Further features and advantages of the invention will become more readily apparent from a consideration of the following detailed description set forth with reference to the accompanying drawing, which specifies and shows a preferred embodiment of the invention; and in which:

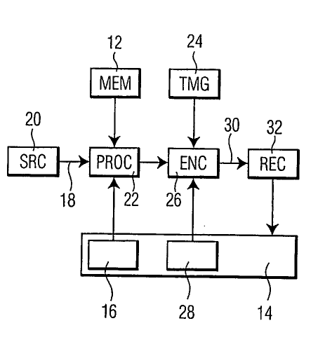

FIG. 1 shows a recorder according to present invention.

The invention, together with attendant advantages, will be best understood by reference to the following detailed description of the preferred embodiment of the invention, taken in conjunction with the accompanying drawing.

A device and method for recording on a medium is described where reproduction, such as playback, recording and/or copying of content is allowed only after certain criteria are met, such as having identical or substantially identical regions codes on the medium, drive and content. Regions codes may be embedded in the content which may be data stream from any source, such as radio, television, Internet or provided on any storage product such as tapes, CDs (Compact Disks), DVDs, solid state memories or any other known memory devices, or combinations thereof. The content may be distributed by any means or medium such as via air, including satellite or any long or short range wireless transmission systems; wires such as cable including fiber optics.

In the following description, numerous specific details are set forth, such as specific type of recording media and content, in order to provide a thorough understanding of the present invention. However, it will be obvious to one skilled in the art that the present invention may be practiced without these specific details. In other instances, well known systems have not been set forth in detail in order to not unnecessarily obscure the present invention.

The illustrative embodiment described herein is an embodiment of a case where the present invention is applied to recording of content on a special recordable DVD referred to as a DVD+P to be described below, where the content includes television signals such as programming or movies. However, those skilled in the art will appreciate that recordation may be on any medium, such as solid-state memory, and the content may be any type of data or signal from any source distributed by any means or medium, such as audio or video stream distributed through the Internet or television and radio signals.

In one embodiment shown in FIG. 1, a reproducing apparatus 10 is provided for recording or playback of content. The reproducing apparatus 10 may be any type such as an optical DVD or CD recorder for example. Illustratively, the recording apparatus 10 is an optical DVD recorder/playback device as is well known in the art, as disclosed in U.S. Patent Application Publication No. U.S. 2001/0,036,268 ('268 Publication) which is incorporated herein by reference in its entirety. For brevity, details of the DVD recorder that are not directly related to the present invention, such as a tuner or receiver to receive content from television radio or the Internet, a spindle motor for spinning the DVD, and an optical system for recording and reading the DVD are not included herein, but are well known in the art such as the system disclosed in the '268 Publication.

The DVD recorder 10 includes a memory 12 where, at time of manufacture for example, at least one region code is stored therein which may be a region such as the United States or Europe. Alternatively or in addition, region codes may be time zones, such as Pacific, Central, Mountain, or Eastern time zones of the United States.

The recordable DVD drive 10 is configured to record on a special medium 14 such as a recordable DVD referred to as DVD+P for DVD-protected. The DVD+P includes at least one region code 16 embedded in the non-user accessible portion of the disk recorded at time of manufacture thereof, for example. Thus, users cannot change, write or add regions into this portion of the disk. The region code embedded in the recordable DVD+P 14 indicates the region where the disk 14 may be used. DVD's with regions codes imbedded therein are well know in the art, as disclosed in U.S. Patent Application Publication No. U.S. 2002/0,006,094 ('094 Publication) which is incorporated herein by reference in its entirety. Further, recordable drives, such as the recordable DVD drive 10, that are designated to work with this media (e.g., DVD+P), are configured to compare the region code included in the DVD+P 14 as will be described, similar to the DVD recorder disclosed in the '094 Publication.

It should be understood that the use of DVD+P is illustrative and any recordable media embedded with region codes may be used. Similarly, any recorder may be used and is not limited to a DVD recordable drive, which is used herein for illustrative purposes.

The recordable DVD drive or DVD recorder 10 receives content 18 from a content source 20, which may be any source, such as television, satellite, radio or Internet broadcast, as well as other medium such as a DVD, CD or tape, and various signals such as those disclosed in U.S. patent application Ser. No. 09/471,750, and published as International Publication No. WO 01/49030, which is incorporated herein by reference in its entirety, and discloses representing rating systems along with region information in a data structure stored in a memory of a multimedia system.

According to the present invention, at least one region code is imbedded in the content 18. For example, in the case where the content 18 is broadcast television signals in the United States, a descriptor such as at least one region code indicative of the origin of the broadcast content is added to the ATSC (American Television Standards Conmmittee) television broadcast stream. The descriptor may be added to any signal or content 18, for example, in pre-existing or new packets of high definition video broadcast signals. Such signals are typically packet based, having packets containing video and audio content for all of the broadcast channels, and packets that describe how to demodulate (or break apart) the signal into viewable video. Such signals also include informational packets embedded therein, such as the time the signal was broadcast as well as program guide information that describe and aid in using the content.

The informational packets, which are already embedded within the broadcast, may be expanded to include region codes or other descriptors, such as time zone of the broadcast origin and/or time of broadcast. Alternatively or in addition, desired descriptors may be included in a new packet added to the video broadcast. This information can be used by receivers that are configured to determine whether the content could be copied, viewed, or retransmitted.

Accordingly, the ATSC television broadcast stream for example may include descriptors that indicate the origin region of broadcast of the content 18, the time zone of the broadcast origin, and/or time of broadcast of the content 18, e.g., rounded to the nearest hour. Other descriptors may also be included for use in allowing and/or preventing reproduction, playback and/or recordation using a properly configured drives and disk, such as the drive 10 and disk 14, where substantially identical descriptors are also included in the drive memory 12 and disk 14 for comparison and allowance of content reproduction as described. Illustratively, these descriptors can be similar to the program related descriptors already carried in the digital television broadcast data stream and thus will not affect the quality of service of the digital television broadcast.

The DVD recorder 10 includes a processor 22 which is configured, prior to recording the content 18, to read and compare the regions code 16 stored on the DVD+P optical disk 14 indicative of the region where the DVD+P can be used to record the content 18, the region code stored in the memory 12 of the DVD recorder 10 indicative of the region where the DVD recorder is allowed to record certain content, and the region code embedded in the content 18 indicative of the region of origin of the broadcast content 18. The processor 22 of the DVD drive or recorder 10 allows recording of the content 18 only when the region codes imbedded in the disk 14, the drive memory 12, and the content 18 match. If the three region codes do not match, then the drive processor 22 prevents recording the content 18 on the disk 14. If multiple region codes are included within the content and/or within the drive and/or are present on the disk, a single region code is required to be the same in all three locations for the region codes to be considered substantially identical and for there to be a match.

In addition or alternate to the region codes, time zone may be embedded in the content 18, disk 14 and drive memory 12, where the drive processor 22 is configured to prevent recording the content 18 on the disk 14 when all three time zones are not substantially identical. Once again if multiple time zones are present within the content and/or within the drive and/or are present on the disk, a single time zone is required to be the same in all three locations for the time zones to be considered substantially identical and for there to be a match. Further, the drive processor 22 may be configured to prevent recording the content 18 on the disk 14 when the difference between the current time and time of broadcast embedded in the content 18 is larger than a predetermined value, as disclosed in U.S. Pat. No. 6,310,956. A timing module 24 may provide the time zone and/or the current time to the processor 22 as originally provided by a user, for example. To prevent tampering by the user, the current time and time zone can be extracted periodically or at random from the broadcast content or other signals with time and date information, such as through the Global Positioning Satellite signals.

For added security, and upon determination that the content 18 is allowed to be recorded, the DVD recorder 10 may further include an encrypter 26 which encrypts the content 18 using at least one encryption key 28 stored in advance on the DVD+P disk 14, e.g., at time of manufacture, in the user inaccessible area, to form encrypted content 30 which is then recorded on the disk 14 by a recorder 32 similar to the system disclosed in the '268 Publication.

Embedding the cryptographic keys 28 in the non-user accessible area of the blank recordable medium, such as the DVD+P 14, provides additional security. Such non-user accessible areas are already used to store decryption keys to decrypt CSS (Content Scramble System) encrypted copyrighted material included in Prepackaged non-recordable DVD, as disclosed in the '268 Publication.

If a trusted source device, either a hardware or a software device, is providing broadcast content 18, where recording is allowed, such as when there is a match between regions codes of the recording device and both regions codes of the disk 14 and content 18, then the DVD recordable drive 10 will automatically read the keys 28 from the DVD+P recordable disk 14, encrypt the broadcast content using the read keys, and record the encrypted content 30 onto the recordable DVD+P disk 14. For added security, the encryption can be performed within the drive 10, with the keys never leaving the drive. When playing back the encrypted content recorded on the DVD+P, the reverse occurs where the drive decrypts the encrypted content using the cryptographic keys 28 that are embedded in the DVD+P.

Determining allowance of recording of content, such as ATSC digital television broadcasts, by comparing three (drive, disk and content) region codes, and once recording is allowed, then encrypting the content using encryption keys preinstalled within the blank disk, and recording the encrypted content provides a system and method for secure authorized recording, such as securing encrypted content that is streamed to a recordable DVD drive. The present invention allows a user to record broadcast content for legitimate purposes, such as time shifting, but will prevent the unauthorized copying and redistribution of this recorded content onto the Internet. For example, in the case where the DVD+P with the content recorded thereon is to be copied, i.e., the recorded DVD+P provides the source content to be copied onto a new DVD+P disk, copying on the new DVD+P disk is allowed only when the three descriptors in the content, new DVD+P, and DVD recorder are substantially identical. Restriction similar to copy restriction may be placed on viewing or playback of a recorded DVD+P disk, where the recorded DVD+P disk cannot be viewed unless there is a match between the descriptor of the recorded DVD+P disk, representing content in this case, and the descriptor of the DVD recorder/player.

Finally, the above-discussion is intended to be merely illustrative of the present invention and should not be construed as limiting the appended claims to any particular embodiment or group of embodiments. For example, the processor 22 may be a dedicated processor for performing in accordance with the present invention or may be a general-purpose processor wherein only one of many functions operates for performing in accordance with the present invention. The processor may operate utilizing a program portion, multiple program segments, or may be a hardware device utilizing a dedicated or multi-purpose integrated circuit. The above system utilized for allowing content reproduction may be utilized in conjunction with further systems. Thus, while the present invention has been described in particular detail with reference to specific exemplary embodiments thereof, it should also be appreciated that numerous modifications and changes may be made thereto without departing from the broader and intended spirit and scope of the invention as set forth in the claims that follow. The specification and drawings are accordingly to be regarded in an illustrative manner and are not intended to limit the scope of the appended claims.

In interpreting the appended claims, it should be understood that:
the word “comprising” does not exclude the presence of other elements or acts than those listed in a given claim;
the word “a” or “an” preceding an element does not exclude the presence of a plurality of such elements;
any reference signs in the claims do not limit their scope;
several “means” may be represented by the same item or hardware or software implemented structure or function; and
each of the disclosed elements may be comprised of hardware portions (e.g., discrete electronic circuitry), software portions (e.g., computer programming), or any combination thereof.

1. A device (10) for reproducing content (18) onto a medium (14) comprising at least one processor (22) which is configured to read a first code or a first set of codes (16) embedded in said medium (14), to read a second code or a second set of codes embedded in said device (10), and to read a third code or a third set of codes embedded in said content (18); to compare said first code (16), said second code, and said third code; and to allow recordation of said content (18) onto said medium (14) when at least said first code (16), said second code, and said third code are substantially identical.

2. The device (10) of claim 1, wherein said processor (22) is configured to allow said recordation of said content (18) onto said medium (14) when at least there is a matched code among codes includes in said first set of codes (16), said second set of codes, and said third set of code.

3. The device (10) of claim 1, wherein said first code (16) includes regions said medium (14) is useable for recording said content (18), said second code includes regions said device (10) is useable for said recording of said content (18), and said third code is indicative of a region of broadcast of said content (18).

4. The device (10) of claim 1, wherein said first code (16) further includes a first time zone or a first set of time zones related to where said medium is useable, said second code further includes a second time zone or a second set of time zones related to where said device (10) is useable, and said third code further includes a third time zone of broadcast origin of said content (18), said processor (22) being further configured to allow said recordation when at least said first time zone, said second time zone and said third time zone are substantially identical.

5. The device (10) of claim 4, wherein said processor (22) is further configured to allow said recordation when at least there is a matched time zone among time zones includes in said first set of time zones, said second set of time zones, and said third time zone.

6. The device (10) of claim 4, wherein said second time zone is obtained from a timing module (24) of said device (10).

7. The device (10) of claim 1, wherein said second code further includes a current time, and said third code further includes a broadcast time of said content, said processor (22) being further configured to prevent said recordation when a difference between said current time and said broadcast time is greater than a threshold value.

8. The device (10) of claim 7, wherein said current time is obtained from a timing module (24) of said device (10).

9. The device (10) of claim 1, wherein said processor (22) is further configured to allow said recordation when a difference between time of broadcast included in said content (18) and a current time provided by a timing module (24) of said device (10) is less than a threshold value.

10. The device (10) of claim 1, further comprising an encoder (26) which is configured to encode said content (10) using at least one key to form an encoded content for recording onto said medium (14), said at least one key being imbedded in said medium (14).

11. A method for recording content (18) onto a medium (14) by a recording device (10) comprising:
reading a first code or a first set of codes (16) embedded in said medium (14);
reading a second code or a second set of codes embedded in said recording device (10);
reading a third code or a third set of codes embedded in said content (18);
comparing said first code (16), said second code and said third code; and
allowing recordation of said content (18) onto said medium (14) when at least said first code, said second code said third code are substantially identical.

12. The method of claim 11, wherein said allowing act allows said recordation when at least there is a matched code among codes includes in said first set of codes (16), said second set of codes, and said third set of codes.

13. The method of claim 11, wherein said first code includes regions said medium (14) is useable for recording said content (18), said second code includes regions said recording device (10) is useable for said recording of said content (18), and said third code is indicative of a region of broadcast of said content (18).

14. The method of claim 11, wherein said first code (16) further includes a first time zone or a first set of time zones related to where said medium (14) is useable, said second code further includes a second time zone or a second set of time zones related to where said device (10) is useable, and said third code further includes a third time zone of broadcast origin of said content (18), wherein said allowing act allows said recordation when at least said first time zone, said second time zone and said third time zone are substantially identical.

15. The method of claim 14, wherein said allowing act allows said recordation when at least there is a matched time zone among time zones includes in said first set of time zones, said second set of time zones, and said third time zone.

16. The method of claim 11, wherein said second code further includes a current time obtained from a timing module (24) of said device (10), and said third code further includes a broadcast time of said content (18), said method further comprising preventing said recordation when a difference between said current time and said broadcast time is greater than a threshold value.

17. The method of claim 11, further comprising preventing said recordation when a difference between time of broadcast included in said content (I 8) and a current time provided from said recording device (10) is less than a threshold value.

18. The method of claim 11, further comprising:
embedding said first code or said first set of codes in said medium (14);
embedding said second code or said second set of codes in said recording device (10); and
embedding a third code in said content (18).

19. The method of claim 11, further comprising:
encrypting said content (18) using keys (28) embedded in said medium (14) to form an encrypted content (30); and
recording said encrypted content (30) onto said medium (14) when said recordation is allowed.

20. A medium (14) having a medium code (16) embedded therein in user non-accessible areas, said medium (14) being configured for recordation of content (18) thereon by a device (10) that allows recordation of said content (18) onto said medium (14) when said medium code (16) matches a device code imbedded in said device (10) and a content code imbedded in said content (18).

21. The medium (14) of claim 20, further comprising at least one key (28) for use by said device (10) for encrypting said content (18) to form an encoded content (30) for recording onto said medium (14).

22. The medium (14) of claim 20, wherein said medium code (16) includes regions said medium (14) is useable for recording said content (18) and said device code includes regions said recording device (10) is useable for said recording of said content (18).

23. The medium (14) of claim 20, wherein said medium code (16) further includes a first time zone or a first set of time zones related to where said medium (14) is useable, said device code further includes a second time zone or a second set of time zones related to where said device (10) is useable, and said content code further includes a third time zone of broadcast origin of said content (18), said device (10) being configured to allow said recordation when at least said first time zone, said second time zones and said third time zone are substantially identical.

24. The medium (14) of claim 23, wherein said device (10) is further configured to allow said recordation when at least there is a matched time zone among time zones includes in said first set of time zones, said second set of time zones, and said third time zone.

25. A signal embodied in a carrier wave comprising:
content (18) for recording by a device (10) on a medium (14); and
a content code indicative of an origin said signal;
wherein said signal is allowed to be recorded by said device (10) when said content code is substantially identical to a medium code (16) imbedded in said medium (14) and a device code imbedded in said device (10).

26. The signal of claim 25, wherein said content code includes a first time zone of broadcast origin of said content (18), said signal being allowed to be recorded by said device (10) when a second time zone included is said medium (14) and related to where said medium (14) is useable, and a third time zone included is said device (10) and related to where said device (10) is useable are substantially identical to said first time zone.

27. A device for playback (10) of recorded content (18) including at least one recorded descriptor, the device (10) comprising a processor (22) which is configured to read said recorded descriptor and to read a device descriptor embedded in said device (10); to compare said recorded descriptor and said device descriptor; and to allow said playback of said recorded content (18) when at least said recorded descriptor and said device descriptor are substantially identical.
